(19) United States
(12) Patent Application Publication
(10) Pub. No.: US 2016/0094355 A1
(43) Pub. Date: Mar. 31, 2016

(54) AUTOMATICALLY TRANSFERRING PRESENTATION CONTROL

(71) Applicant: Lenovo (Singapore) Pte. Ltd., Singapore (SG)

(72) Inventors: Rod D. Waltermann, Rougemont, NC (US); Nathan J. Peterson, Durham, NC (US); Russell Speight VanBlon, Raleigh, NC (US); John Carl Mese, Cary, NC (US); Arnold S. Weksler, Raleigh, NC (US)

(21) Appl. No.: 14/502,273

(22) Filed: Sep. 30, 2014

(51) Int. Cl. H04L 12/18; G06F 3/0484

(52) U.S. Cl. CPC H04L 12/1822; G06F 3/0484

(57) ABSTRACT

One embodiment provides a method, comprising: associating, using a processor, an information handling device with a participant; identifying, using a processor, a participant as a current presenter, wherein the current presenter's information handling device is used as a presentation device; identifying, using a processor, a second participant as a new presenter; and automatically transferring, using a processor, the presentation device from the current presenter's information handling device to the new presenter's information handling device. Other aspects are described and claimed.

### BACKGROUND

To exchange information and ideas to a group of people, a person may hold a group based session (e.g., training, meetings, conferences, etc.). The traditional method of conducting a group based session requires the group of people (i.e., participants) to gather together in one location to effectively participate in the session. Now web or network based conferencing software allows participants to participate from multiple locations, for example, one participant may be in a conference room at a work location, while another participant may be working out of their office at home. Whether the participants are in a single location or multiple locations, some group based sessions may have multiple presenters each having their own information handling devices (e.g., tablets, laptop computers, personal computers, smart phones, etc.). When a new presenter (i.e., not the current presenter) needs to display their portion of the presentation, some form of transferring control of the presentation may need to occur.

### BRIEF SUMMARY

In summary, one aspect provides a method, comprising: associating, using a processor, an information handling device with a participant; identifying, using a processor, a participant as a current presenter, wherein the current presenter's information handling device is used as a presentation device; identifying, using a processor, a second participant as a new presenter; and automatically transferring, using a processor, the presentation device from the current presenter's information handling device to the new presenter's information handling device.

Another aspect provides an information handling device, comprising: a processor; a memory device that stores instructions executable by the processor to: associate an information handling device with a participant; identify a participant as a current presenter, wherein the current presenter's information handling device is used as a presentation device; identify a second participant as a new presenter; and automatically transfer the presentation device from the current presenter's information handling device to the new presenter's information handling device.

A further aspect provides a product, comprising: a storage device having code stored therewith, the code being executable by a processor and comprising: code that associates an information handling device with a participant; code that identifies a participant as a current presenter, wherein the current presenter's information handling device is used as a presentation device; code that identifies a second participant as a new presenter; and code that automatically transfers the presentation device from the current presenter's information handling device to the new presenter's information handling device.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of automatically transferring presentation control.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

In order to convey information to multiple people at the same time, group based sessions may be conducted. These group based sessions (e.g., meetings, conferences, trainings, etc.) may have multiple presenters. For example, a training session may be scheduled for eight hours, but different presenters teach different sections of the training. Switching between the multiple presenters can be both time consuming and disruptive. For example, each presenter in group based session may have their own information handling device (e.g., tablet, laptop computer, personal computer, smart phone, etc.) which may store their part of the presentation (e.g., demonstration, lecture, speech, etc.). The switch between the presenters may require swapping wires, control, software, or even hardware. Alternatively, a presenter may have presentation slides which may be given to a lead presenter, but may have additional information, not included in the presentation slides, in a different form (e.g., word processing document, spreadsheet, images, etc.) stored on their own information handling device. This information may not be accessible to the person presenting and may thereby decrease the effectiveness or efficiency of the session.

One current method of causing less disruption is to have a main presenter who has all the parts of the presentation on their information handling device. When a new presenter is ready to present the main presenter either has to give up control of their information handling device or has to control the presentation of the new presenter. An additional disadvantage of this method is if the new presenter has additional information that is only available on their own information handling device, they no longer have access to it using the information handling device of the main presenter.

Another solution requires whichever participant is presenting to manually connect their information handling device to the projector. This can cause disruption due to the need to manually unplug and plug in projectors and update screen settings. If some of the participants are located at a different location, they may see a blank screen while this switch is occurring. Additionally, if the session is being conducted using web based conferencing software (e.g., CISCO WEBEX, GOTOMEETING, ILINC, etc.) then control of the software conference may need to be switched to the new presenter. CISCO WEBEX is a registered trademark of Cisco Technology, Inc. in the United States and other countries. GOTOMEETING is a registered trademark of Citrix Online, LLC in the United States and other countries. ILINC is a registered trademark of EDT Learning, Inc. in the United States and other countries.

In some cases, a room may support wireless projecting. This may allow one participant to transfer control to a different participant, without the need to switch wires and hardware. However, this method does require the presenters to switch software. Generally, this method requires the current presenter or the presenter designated as the leader to manually assign control to the new presenter. Both the new presenter and leader must stop whatever they are doing to transfer control of the presentation to the new presenter.

One of the drawbacks of the existing solutions is the time and disruption that is caused while transferring control of the presentation to a new presenter. Additionally, none of the current solutions identify the presenter to be presenting and automatically assigns control of the presentation to the new presenter.

Accordingly, an embodiment provides a method of identifying a participant as a presenter and automatically transferring the presentation device to the information handling device associated with the identified participant. An embodiment may first associate an information handling device with a participant. One embodiment may then identify a group session participant as a presenter and use that participant's information handling device as the presentation device. If an embodiment identifies a different participant as a new presenter, then an embodiment may automatically transfer control of the presentation to the new presenter's information handling device. In one embodiment, the current presenter may be prompted to release control of the presentation device to the new presenter.

The illustrated example embodiments will be best understood by reference to the figures. The following description is intended only by way of example, and simply illustrates certain example embodiments.

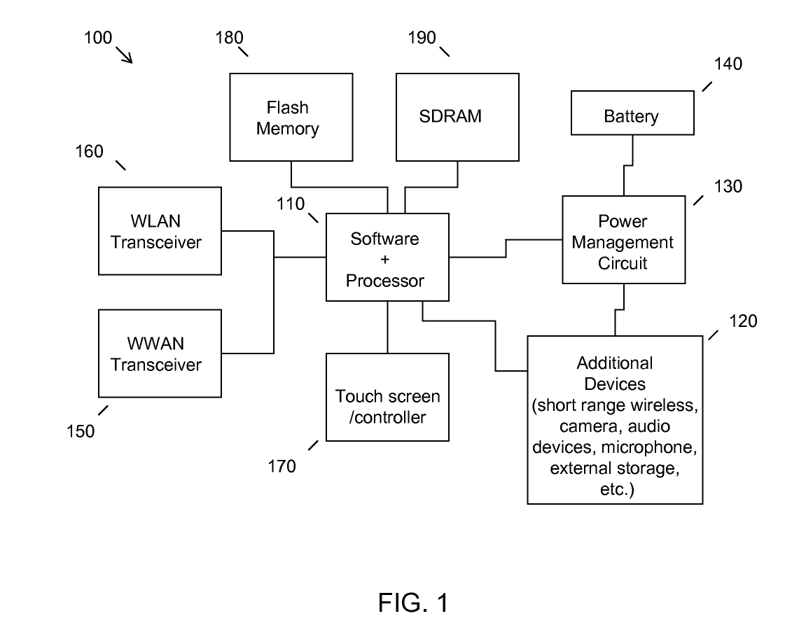

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally devices 120 are commonly included, e.g., a recognition device such as a camera, microphone, biometric scanner, etc. System 100 often includes a touch screen 170 for data input and display/rendering. System 100 also typically includes various memory devices, for example flash memory 180 and SDRAM 190.

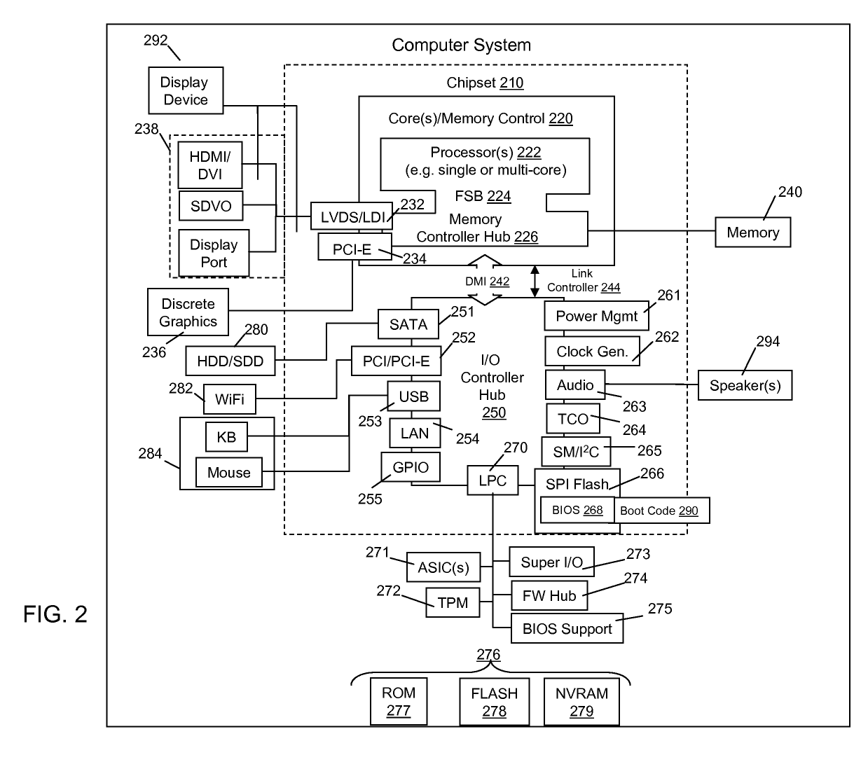

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a LVDS interface 232 for a display device 292. A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices, generally, and/or other electronic devices which participants may use to participate (e.g., present information, store presentation data, connect to the group session, etc.) in a group session. For example, the circuitry outlined in FIG. 1 may be implemented in a tablet or smart phone embodiment, whereas the circuitry outlined in FIG. 2 may be implemented in a personal computer embodiment.

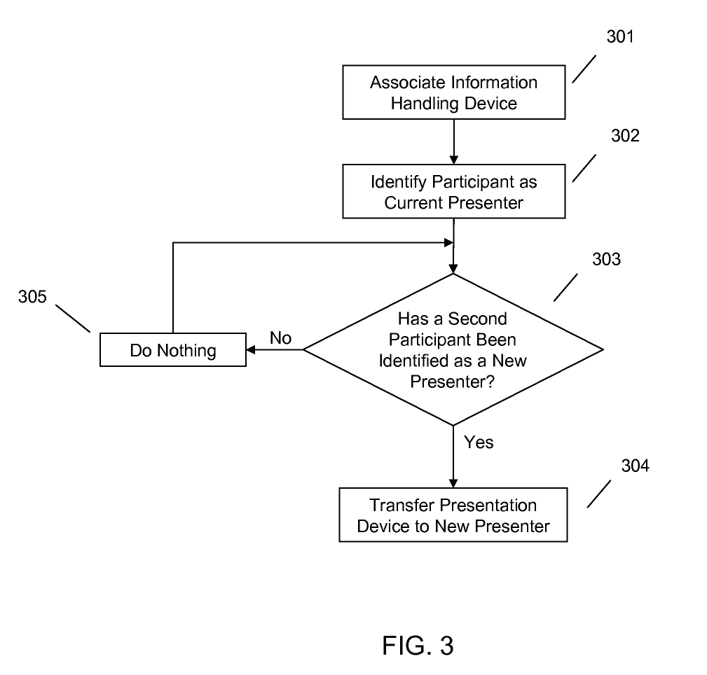

Referring now to FIG. 3, an embodiment may associate an information handling device with a participant at 301. This association may allow an embodiment to determine which information handling device belongs to a particular participant. To make this determination, an embodiment may first identify the information handling device. As an example, an embodiment may identify the information handling device using information read from the information handling device (e.g., serial number, information handling device ID, etc.). Alternatively or additionally, an embodiment may identify the information handling device using information received from the network (e.g., MAC address, network ID, IP address, etc.). Other methods of identifying the information handling device are possible.

In addition to identifying the information handling device, an embodiment may receive data from the information handling device which designates the information handling device as belonging to a particular participant. This data may allow an embodiment to associate the information handling device with the particular participant. In one embodiment this data may be received through the participant logging into the information handling device with their user credentials. For example, a participant may log into their personal computer system using a username and password. Once the participant has logged in, the personal computer may associate that particular personal computer with the participant whose credentials were used to log into the account.

Additionally or alternatively, in one embodiment, the participant may enter user credentials when accessing the group session. For example, a user may access a virtual meeting by opening a website and then entering a user ID and password to log into the meeting. An embodiment may then associate the information handling device that the participant has used to log into the meeting with the person whose user credentials were entered. Other methods of associating a participant with an information handling device are possible. For example, a digital assistant may be employed to determine which participant is assigned to a particular information handling device.

At 302, an embodiment identifies a participant as a current presenter (i.e., a participant who is currently presenting information). This participant's (i.e., current presenter) information handling device may now be designated as the presentation device (e.g., the information handling device being used to display information to the group during the group session, the information handling device being used to lead the group session, etc.). At 303, an embodiment may determine whether a second participant has been identified as a new presenter (i.e., a participant who is to present information next). In one embodiment, the identification of a presenter may be through user input where the participant designates a participant, which may be themselves, as the presenter. For example, a participant may log into their information handling device and start a meeting. Upon the start of the meeting, the participant may be prompted to designate a lead presenter. An embodiment may then identify this lead presenter as the current presenter.

In one embodiment the identification of a participant as a presenter may be accomplished using a recognition device (e.g., image capture device, audio capture device, biometric capture device, etc.). An embodiment may use a recognition device to capture an indication by a participant indicating which participant should be the presenter. For example, an embodiment may use a microphone to capture that a participant has said “John will present.” An embodiment may then identify that John has been identified as a new presenter. As another example, an embodiment may detect that a participant is making a hand gesture to indicate that they should be the new presenter. An embodiment many then identify this person as the new presenter.

An embodiment may use other information available to identify a participant as a presenter. For example, an embodiment may capture data from a schedule or agenda of the meeting to determine which participant should be presenting at a specific time. As another example, an embodiment may note the current presenter and have a default that a certain participant is always the presenter after the current presenter. In one embodiment multiple methods may be used to identify the presenters. For example, the current presenter may be identified through user input designating the participant as the presenter, while the new presenter may be identified using a recognition device.

If a second participant has not been identified in step 303, an embodiment may do nothing and continue to wait for a second participant to be identified as a new presenter at 305. However, if a second participant is identified as a new presenter, then an embodiment may automatically transfer the presentation device from the current presenter's information handling device to the new presenter's information handling device at 304. The transferring of the presentation device may include transferring all display and control capabilities to the new information handling device or may just include transferring control.

In one embodiment, the automatic transferring includes disabling the current presenter's information handling device as the presentation device. In other words, the current presenter's information handling device will no longer display or control the presentation material. An embodiment may then enable the new presenter's information handling device as the presentation device. In other words, the new presenter's information handling device will display and control the presentation material. For example, a group of participants may be in a meeting where the current presenter is the meeting lead and the information handling device of the current presenter is the presentation device. Once the current presenter has completed presenting and a new presenter has been identified, an embodiment may disable the current presenter's information handling device as the presentation device, and the new presenter's information handling device is now used as the presentation device. Thereby allowing the current presenter to leave the meeting with their information handling device without disrupting the meeting.

Additionally or alternatively, an embodiment may assign control of the presentation device from the current presenter's information handling device to the new presenter's information handling device. In other words, the current presenter's information handling device will still act as the display device, but the new presenter has control over the presentation material. For example, for a training session a laptop computer may be set up to display the presentation materials. Once a new presenter has been identified, the training laptop will still display the presentation materials, but the new presenter can control the presentation materials from their own information handling device.

One embodiment may prompt the current presenter before transferring control. For example, an embodiment may prompt the current presenter requesting the current presenter release control to the new presenter. Alternatively or additionally, the new presenter may be prompted confirming that they are supposed to be the new presenter. One embodiment may include multiple prompts. For example, both the current presenter and the new presenter may both be prompted to confirm the transfer. One embodiment may prompt a third participant. For example, if the group session has a lead participant, an embodiment may prompt that participant rather than the current presenter or the new presenter.

As an overall example, a group of meeting participants may log into a meeting. As each participant logs into the meeting, an embodiment may associate the information handling devices used to log into the meeting with the participants whose user credentials were used to log into the meeting. Thus, each information handling device is associated with a meeting participant.

An embodiment may then use a microphone to identify that someone has indicated that John will be presenting. In identifying the participant, an embodiment may access information to determine which information handling device is associated with the participant. For example, an embodiment may access the group session participant roster and determine the John who is included in the group session. As another example, an embodiment may, if the participants have logged into the meeting, access the log in credentials of the participants to determine if a John logged in. An embodiment may then identify John's information handling device, previously associated with him, as the presentation device.

As the meeting progress, John may say “who is supposed to present next?” An embodiment may see that a hand is waving and determine that Jacob is waving his hand. The embodiment may then automatically transfer control of the presentation to Jacob's information handling device without any further input from any of the meeting participants. Alternatively, an embodiment may prompt the current presenter to release control of the presentation to the newly identified presenter.

Accordingly, as illustrated by the example embodiment and figures, an embodiment provides a method of identifying a group session participant as a presenter. After an embodiment has associated an information handling device with that presenter, an embodiment will use that information handling device as the presentation device. An embodiment may then identify (e.g., through user input, a recognition device, etc.) a new presenter and automatically transfer the presentation device to the new presenter's information handling device. The transfer may include transferring display and control to the new presenter's information handling device, or it may just include transferring control of the information handling device.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
associating, using a processor, an information handling device with a participant;
identifying, using a processor, a participant as a current presenter, wherein the current presenter's information handling device is used as a presentation device;
identifying, using a processor, a second participant as a new presenter; and
automatically transferring, using a processor, the presentation device from the current presenter's information handling device to the new presenter's information handling device.

2. The method of claim 1, wherein the associating comprises receiving data from the information handling device, wherein the data designates the information handling device as being associated with a participant.

3. The method of claim 2, wherein the data comprises user credentials received when the participant accesses the information handling device.

4. The method of claim 2, wherein the data comprises user credentials received when the participant accesses conferencing software.

5. The method of claim 1, wherein the identifying comprises using a recognition device to capture an indication by a participant indicating the participant is to be a presenter, wherein the recognition device is selected from the group consisting of: an image capture device, an audio capture device, and a biometric capture device.

6. The method of claim 1, wherein the identifying comprises capturing data from a schedule, wherein the schedule identifies a participant as a presenter.

7. The method of claim 1, wherein the identifying comprises receiving user input, wherein the user input designates a participant as a presenter.

8. The method of claim 1, wherein the automatic transferring comprises disabling the current presenter's information handling device as the presentation device and enabling the new presenter's information handling device as the presentation device.

9. The method of claim 1, wherein the automatic transferring comprises assigning control from the current presenter's information handling device to the new presenter's information handling device.

10. The method of claim 1, further comprising displaying a prompt, wherein the prompt requests the current presenter to release control to the new presenter.

11. An information handling device, comprising:
a processor;
a memory device that stores instructions executable by the processor to:
associate an information handling device with a participant;
identify a participant as a current presenter, wherein the current presenter's information handling device is used as a presentation device;
identify a second participant as a new presenter; and
automatically transfer the presentation device from the current presenter's information handling device to the new presenter's information handling device.

12. The information handling device of claim 11, wherein to associate comprises receiving data from the information handling device, wherein the data designates the information handling device as being associated with a participant.

13. The information handling device of claim 12, wherein the data comprises user credentials received when the participant accesses the information handling device.

14. The information handling device of claim 11, wherein to identify comprises using a recognition device to capture an indication by a participant indicating the participant is to be a presenter, wherein the recognition device is selected from the group consisting of: an image capture device, an audio capture device, and a biometric capture device.

15. The information handling device of claim 11, wherein to identify comprises capturing data from a schedule, wherein the schedule identifies a participant as a presenter.

16. The information handling device of claim 11, wherein to identify comprises receiving user input, wherein the user input designates a participant as a presenter.

17. The information handling device of claim 11, wherein to automatically transfer comprises disabling the current presenter's information handling device as the presentation device and enabling the new presenter's information handling device as the presentation device.

18. The information handling device of claim 11, wherein to automatically transfer comprises assigning control from the current presenter's information handling device to the new presenter's information handling device.

19. The information handling device of claim 11, wherein the instructions are further executable to display a prompt, wherein the prompt requests the current presenter to release control to the new presenter.

20. A product, comprising:
a storage device having code stored therewith, the code being executable by a processor and comprising:
code that associates an information handling device with a participant;
code that identifies a participant as a current presenter, wherein the current presenter's information handling device is used as a presentation device;
code that identifies a second participant as a new presenter; and
code that automatically transfers the presentation device from the current presenter's information handling device to the new presenter's information handling device.
